(19) United States
(12) Patent Application Publication
(10) Pub. No.: US 2021/0181658 A1
(43) Pub. Date: Jun. 17, 2021

(54) IMAGE FORMING APPARATUS WITH INDIVIDUALLY CONTROLLABLE HEATING MEMBERS

(71) Applicant: TOSHIBA TEC KABUSHIKI KAISHA, Tokyo (JP)

(72) Inventor: Masaya ARAKAWA, Hiratsuka Kanagawa (JP)

(21) Appl. No.: 17/003,859

(22) Filed: Aug. 26, 2020

(30) Foreign Application Priority Data
Dec. 17, 2019 (JP) 2019-227231

(51) Int. Cl. G03G 15/20

(52) U.S. Cl. CPC G03G 15/205

(57) ABSTRACT

According to one or more embodiments, an image forming apparatus includes a transfer unit, a heating unit, and a controller. The transfer unit transfers a toner image indicating a document image to a sheet. The heating unit comprises a plurality of heating members in a direction orthogonal to a sheet conveyance direction and is configured to heat the sheet to which the toner image has been transferred. The controller controls heat generation amounts of the heating members in accordance with an operation mode determined based on a document image type.

### CROSS-REFERENCE TO RELATED APPLICATIONS

This application is based upon and claims the benefit of priority from Japanese Patent Application No. 2019-227231, filed on Dec. 17, 2019, the entire contents of which are incorporated herein by reference.

### FIELD

Embodiments described herein relate generally to an image forming apparatus.

### BACKGROUND

A fixing device of an on-demand type is known as a fixing system for an image forming apparatus. The fixing device comprises a plurality of heating elements arranged in a main scanning direction. The fixing device generates heat by the heating elements in accordance with an image area within a sheet on which an image is to be formed and fixed. In such fixing device, the greater the number of the heating elements or number of divisions in a heating element group, the more efficiently heating of sheets having different sizes can be performed.

However, the amount of toner transferred onto a sheet of any size varies depending on the particular image being formed on the sheet. Therefore, in some instance, increasing the number of the heating elements (or finely dividing the heating element group) may achieve efficient heating only to some limited extent, rather than what might be considered maximum possible efficiency in view a consideration of the image size being printed on the sheet.

### BRIEF DESCRIPTION OF THE DRAWINGS

FIG. 1 depicts an external view of an image forming apparatus according to an embodiment.

FIG. 2 depicts a block diagram of an image forming apparatus according to an embodiment.

FIG. 3 depicts a fixing device in a front cross-sectional view according to an embodiment.

FIG. 4 depicts a heater unit in a schematic view according to an embodiment.

FIG. 5 depicts a heating element group in a case of a heat generation mode of a control A type according to an embodiment.

FIG. 6 depicts a heating element group in a case of a heat generation mode of a control B1 type according to an embodiment.

FIG. 7 depicts a heating element group in a case of a heat generation mode of a control B2 type according to an embodiment.

FIG. 8 depicts a heating element group in a case of a heat generation mode of a control B3 type according to an embodiment.

FIG. 9 is a diagram of a correspondence between an image type, an operation mode, and a control mode according to an embodiment.

FIG. 10 is a flowchart of control by a controller of an image forming apparatus according to an embodiment.

FIG. 11 is a diagram of a correspondence between an operation mode and a control mode according to an embodiment.

### DETAILED DESCRIPTION

According to one or more embodiments, an image forming apparatus includes a transfer unit (e.g., a transfer belt), a heating unit, and a controller. The transfer unit transfers a toner image corresponding to a document image to a sheet. The heating unit comprises a plurality of heating members in a direction orthogonal to a sheet conveyance direction and is configured to heat the sheet to which the toner image has been transferred. The controller is configured to control heat generation of the plurality of heating members in accordance with an operation mode set according to a type of the document image or the like.

Hereinafter, an image forming apparatus according to example embodiments will be described.

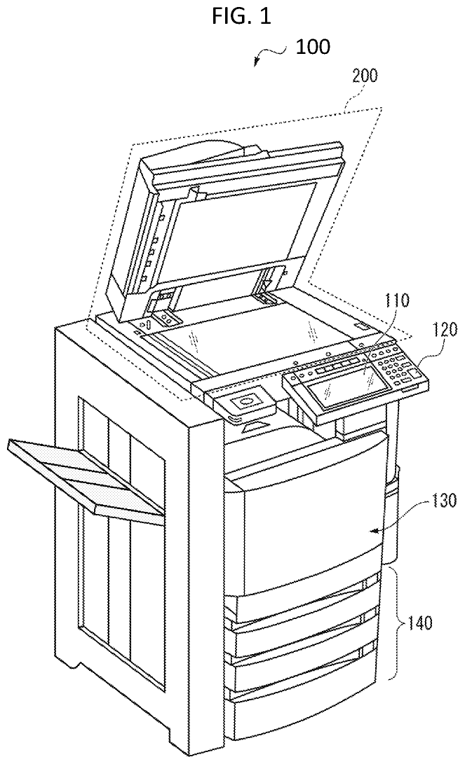

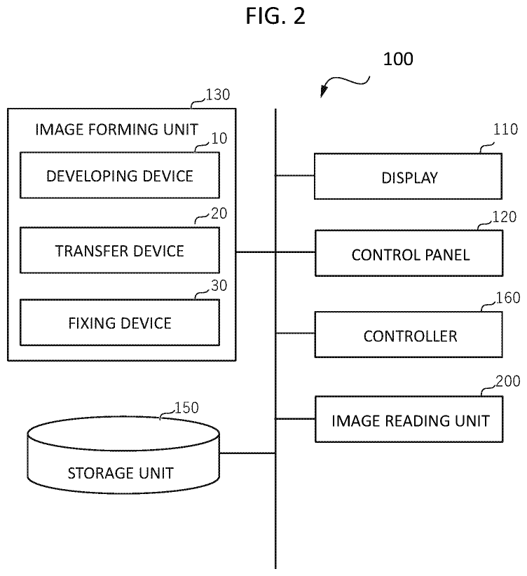

FIG. 1 is an external view illustrating an overall configuration example of an image forming apparatus 100 according to the embodiment. FIG. 2 is a hardware block diagram of the image forming apparatus 100 according to the embodiment. The image forming apparatus 100 is, for example, a multifunction peripheral (MFP) device. As shown in FIG. 1, the image forming apparatus 100 includes a display 110, a control panel 120, an image forming unit 130, and a sheet storage unit 140. As shown in FIG. 2, the image forming apparatus 100 includes a storage unit 150, a controller 160, and an image reading unit 200.

The image forming apparatus 100 forms an image on a sheet by using a developer. The developer is fixed to the sheet by being heated. The sheet is, for example, a paper or a label sheet. In general, sheet may be any material as long as the image forming apparatus 100 can form and fix an image on a surface thereof.

The display 110 is an image display device such as a liquid crystal display, an organic EL (Electro Luminescence) display, or the like. The display 110 displays various kinds of information related to the image forming apparatus 100.

The control panel 120 includes a plurality of buttons. The control panel 120 receives an operation performed by a user. The control panel 120 outputs a signal corresponding to the operation performed by the user to the controller 160 of the image forming apparatus 100. The display 110 and the control panel 120 may be configured as an integrated touch panel.

The image forming unit 130 forms an image on the sheet based on image information generated by the image reading unit 200 and/or image information received from, for example, an external device through a communication path. The image forming unit 130 includes, for example, a developing device 10, a transfer device 20, and a fixing device 30. The image forming unit 130 forms an image by, for example, the following processes. The developing device 10 of the image forming unit 130 forms an electrostatic latent image on a photosensitive drum based on the generated or received image information. The developing device 10 of the image forming unit 130 forms a visible image by attaching a developer to a electrostatic latent image. One example of the developer is a toner. Examples of the toner include a decolorable toner, a non-decolorable toner (or a normal toner), and a decorative toner (e.g., a specialized toner). Decolorable toner is a toner that loses color due to heating process. In the following description, the developer will be described as comprising a normal toner.

The transfer device 20 of the image forming unit 130 transfers a toner image corresponding an image to be printed on to a sheet. The fixing device 30 of the image forming unit 130 heats and presses the toner image onto the sheet. The sheet on which the image is to be formed may be a sheet accommodated in the sheet storage unit 140 or may be a sheet fed by a manual feed.

The sheet storage unit 140 accommodates a sheet or a plurality of sheets used for image formation in the image forming unit 130. The storage unit 150 may be a storage device such as a magnetic hard disk device or a semiconductor storage device. The storage unit 150 stores data and/or programs to be used when the image forming apparatus 100 operates. The storage unit 150 may temporarily store the image information of the image formed in the image forming apparatus 100.

The controller 160 may comprise a processor such as a central processing unit (CPU) and a memory. The controller 160 reads out a program stored in the storage unit 150 in advance and executes the program. The controller 160 controls the operation of each device and unit included in the image forming apparatus 100.

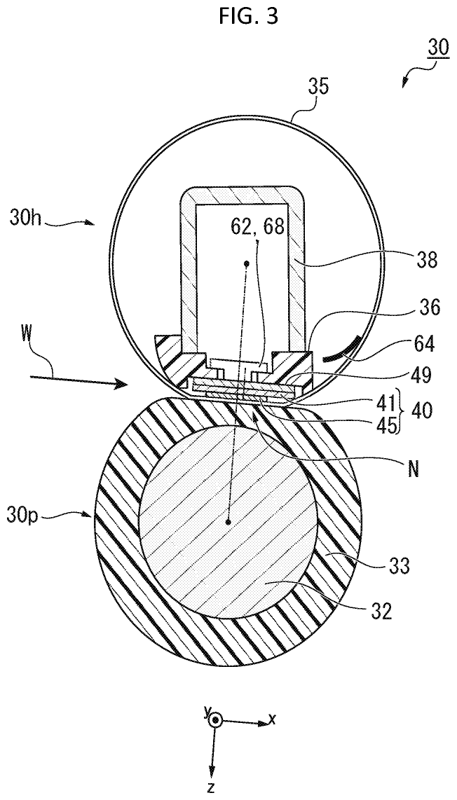

The controller 160 controls an amount of heat generated by each heating element by controlling electric power supplied to a heating element group 45 shown in FIG. 3. For example, the control of the electric power may be performed by controlling an energization amount. The control of the energization amount may be, for example, a phase control, or a wave number control.

The image reading unit 200 reads image information to be read as brightness and darkness of reflected light from a document or the like. The image reading unit 200 records the read image information. The recorded image information may be transmitted to another information processing apparatus via a network. The recorded image information may then be formed as a visible image on a sheet by the image forming unit 130. The image reading unit 200 may include an auto document feeder (ADF).

FIG. 3 is a front cross-sectional view of the fixing device 30 according to the embodiment. The fixing device 30 of the embodiment includes a pressure roller 30p and a film unit 30h.

The pressure roller 30p is configured to press a surface thereof against the film unit 30h and to be rotatably driven. The pressure roller 30p forms a nip N with the film unit 30h when the roller surface is pressed against the film unit 30h. The pressure roller 30p applies pressure to the visible toner image on the sheet that has entered the nip N. When the pressure roller 30p is driven to rotate, the pressure roller 30p conveys the sheet according to the rotation. The pressure roller 30p includes, for example, a core metal 32, an elastic layer 33, and a release layer (not separately depicted).

The core metal 32 is formed of a metal material such as stainless steel in a columnar shape. Both ends of the core metal 32 in the axial direction are rotatably supported. The core metal 32 is driven to rotate by a motor or the like. The core metal 32 contacts a cam member or the like.

The elastic layer 33 is formed of an elastic material such as silicone rubber. The elastic layer 33 is formed to have a constant thickness on an outer peripheral surface of the core metal 32. A release layer (not separately depicted) is formed on the outer peripheral surface of the elastic layer 33. The release layer is formed of a resin material such as PFA (tetrafluoroethylene-perfluoroalkyl vinyl ether copolymer).

The pressure roller 30p rotates by being driven to rotate by a motor. When the pressure roller 30p rotates in a state where the nip N is formed, a cylindrical film 35 of the film unit 30h rotates in a driven manner. The cylindrical film may be a thin film. The pressure roller 30p rotates in a state where the sheet is disposed in the nip N, and thereby conveys the sheet in the conveyance direction W.

The film unit 30h heats the image on the sheet that has entered the nip N. The film unit 30h includes a cylindrical film 35 (e.g., a belt, drum, or the like), a heater unit 40, a heat transfer member 49, a support member 36, a stay 38, a heater temperature sensor 62, a thermostat 68, and a film temperature sensor 64.

The cylindrical film 35 is in a tubular shape. The cylindrical film 35 includes, in order from the inner peripheral side, a base layer, an elastic layer, and a release layer. The base layer is formed of a material such as nickel (Ni) in a cylindrical shape. The elastic layer is laminated on the outer peripheral surface of the base layer. The elastic layer is formed of an elastic material such as silicone rubber. The release layer is laminated on the outer peripheral surface of the elastic layer. The release layer is formed of a material such as a PFA resin.

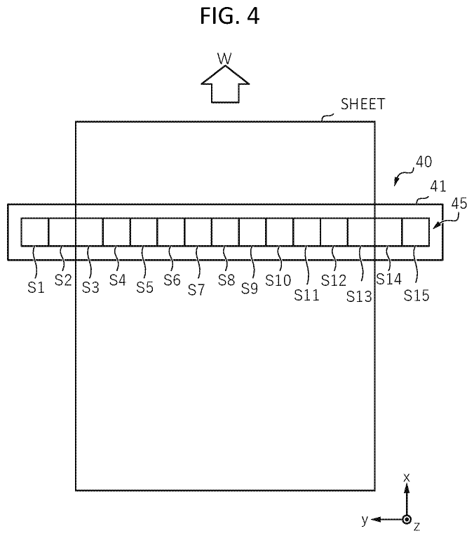

FIG. 4 is a schematic view of the heater unit 40. The heater unit 40 is provided downstream of the transfer device 20 in the sheet conveyance direction.

The heater unit 40 includes a substrate (may also be referred to as a heating element substrate herein) 41 and a heating element group 45. The substrate 41 is formed of a metal material such as stainless steel or nickel, a ceramic material such as aluminum nitride, or the like. The substrate 41 is formed in a plate shape having a thin rectangular shape. The substrate 41 is disposed on the inner side in the radial direction of the cylindrical film 35. In the substrate 41, the axial direction of the cylindrical film 35 is a longitudinal direction.

The heating element group 45 is formed on the surface of the substrate 41. The heating element group 45 includes a plurality of heating elements. Each heating element is an example of a heating member that heats the sheet. Each heating element is formed using a heating resistor such as a silver-palladium alloy. In the example of FIG. 4, the heating element group 45 includes 15 heating elements S1 to S15. When the heating elements S1 to S15 are not distinguished from each other herein, they will be referred to as heating elements S or, collectively, a heating element S. An energization amount (e.g., supplied current) for each of the heating elements S is independently controlled by the controller 160. As shown in FIG. 4, the plurality of heating elements S are orthogonal to the conveyance direction W of the sheet.

Referring back to FIG. 3, the heater unit 40 is disposed inside the cylindrical film 35. A lubricant is applied to the inner peripheral surface of the cylindrical film 35. The heater unit 40 contacts the inner peripheral surface of the cylindrical film 35 via the lubricant. When the heater unit 40 generates heat, viscosity of the lubricant decreases. This reduces friction between the heater unit 40 and the cylindrical film 35. In the present embodiment, the cylindrical film 35 is a belt-shaped thin film that slides on the surface of the heater unit 40 while being in contact with the heater unit 40 on one surface.

The support member 36 is formed of a resin material such as a liquid crystal polymer. The support member 36 supports the heater unit 40. The support member 36 supports the inner peripheral surface of the cylindrical film 35 at both ends of the heater unit 40.

The stay 38 is formed of a steel plate material or the like. The cross section of the stay 38 may be formed in a U-shape, for example. The stay 38 is mounted so as to close the opening portion of the U shape by the support member 36. Both end portions of the stay 38 are fixed to a housing of the image forming apparatus 100. As a result, the film unit 30h is supported by the image forming apparatus 100.

The heater temperature sensor 62 is disposed near the heater unit 40. The heater temperature sensor 62 measures a temperature of each heating element S.

The thermostat 68 is disposed in the substantially same manner as the heater temperature sensor 62. When the measured temperature of the heater unit 40 exceeds a predetermined temperature, the thermostat 68 cuts off an energization of the heating element group 45.

Next, control of a heat generation amount of the heating element S will be described. The control of the heat generation amount includes 2 control patterns of a control A and a control B in a roughly divided manner. The control A is an example of a first control. The control B is an example of a second control. A control pattern common to both the control A and the control B is that the heating element(s) S corresponding to a region through which the sheet does not pass through does not generate heat. Control patterns of the heating elements S in the following description are for those corresponding to the region through which the sheet passes, unless otherwise specified.

The control A causes all the heating elements S to generate heat at predetermined power (hereinafter, also referred to as “power X”). In the present embodiment, the power X is a maximum power that can be supplied to the heating element S. Therefore, the heat generation at the power X maximizes the heat generation from the heating element S. The control A is a control in which the printing quality can be maintained even when the toner is transferred to an entire surface of a sheet (so-called solid coating or complete coverage). Therefore, the control A is suitable for image formation of a document image (for example, a photograph or the like) in which a relatively large amount of toner is transferred.

On the other hand, the control B causes at least some of the heating elements S to generate heat less than the power X. In the control B, the power of at least one of the heating elements S is less than the power X. Therefore, the control B is a control for reducing the amount of heat generation as compared to the control A. The control B is a control suitable for a case where a document image is formed of a character, a letter, a symbol, a text or the like (may be collectively referred to as a text image herein). The control B enables the sheet to be efficiently heated without causing the heating element S to generate heat more than necessary for a producing a text image. Therefore, in the control B, it is possible to limit the power consumption.

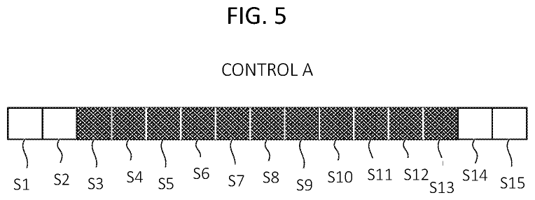

The control A and the control B will be described in further detail with reference to FIGS. 5 to 8. In FIGS. 5 to 8, the heating elements S1, S2, S14, and S15 are heating elements corresponding to a region through which the sheet does not pass. Therefore, the controller 160 does not generate heat with these heating elements S1, S2, S14, and S15. In FIGS. 5 to 8, the heating elements S indicated by white indicates that no heat is generated, and the heating elements S indicated by a color other than white (e.g., black fill, diagonal line, hatching, or shading) indicates that heat is generated.

FIG. 5 is a diagram illustrating a heat generation mode in the control A. The control A is a control for causing the heating elements S3 to S13 to generate heat with the power X. Therefore, in FIG. 5, all of the heating elements S3 to S13 are shown in black.

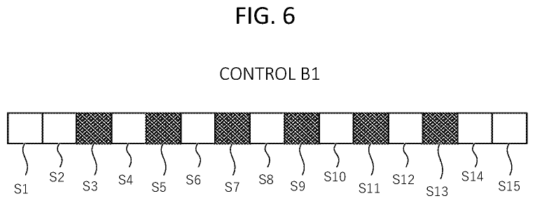

FIGS. 6, 7 and 8 are diagrams illustrating heat generation modes in the control B. The control B includes three types of controls: a control B1, a control B2, and a control B3. FIG. 6 is a diagram illustrating a heat generation mode of the control B1. The control B1 is a control for causing a part of the plurality of heating elements S to generate heat. In the example of FIG. 6, the controller 160 causes the heating elements S3, S5, S7, S9, S11, and S13 to generate heat with the power X. On the other hand, the controller 160 does not generate heat of the heating elements S4, S6, S8, S10, and S12. The controller 160 generates heat only for some of the heating element S, thereby suppressing the amount of heat generation compared to the control A.

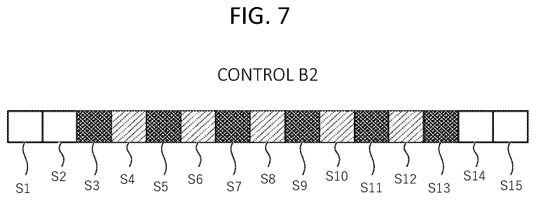

Each of the controls B2 and B3 is a control in a case where the heating element S can be variably controlled (e.g., with varying power levels). In the variable control, the heating element S can be controlled by a power between the power X and the power 0, not only just by ON (power X) and off (power 0). FIG. 7 is a diagram illustrating a heat generation mode of the control B2. The control B2 is a control for causing the heating element S to generate heat at a different power. In the example of FIG. 7, the controller 160 causes the heating elements S3, S5, S7, S9, S11, and S13 to generate heat with the power X. The controller 160 causes the heating elements S4, S6, S8, S10, and S12 to generate heat with a power Y (0<power Y<power X). When the heat generation amount of the heating element S can be variably controlled as in this example, the heat generation amount of the heating element S can be controlled more accurately than the control B1, so that it is possible not only to efficiently heat the sheet, but also to improve the printing quality.

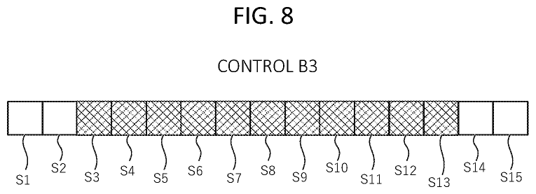

FIG. 8 is a diagram illustrating a heat generation mode of the control B3. The control B3 is a control for causing the heating element S to generate heat with a power Z (0<power Z<power X). In the example of FIG. 8, the controller 160 causes the heating elements S3 to S13 to generate heat with the power Z. When the heat generation amount of the heating element S can be variably controlled as in this example, the heat generation amount of the heating element S can be controlled more accurately than the control B1, so that it is possible not only to more efficiently heat the sheet, but also to further improve the printing quality. In addition, since a temperature of the heating element S is uniform as compared to the control B2, unevenness is less likely to occur.

The controls B1, B2, and B3 described above are examples of the control B, but the control B may be any control as long as the control is capable of suppressing the amount of heat generation.

The controller 160 controls any one of the control A and the control B in accordance with an operation mode. The operation mode is determined based on a type of the document image. As a type of the document image, there are a character image type in which a document image is formed of characters and a photograph image type in which a document image represents a photograph. The character image type and the photo image type are set by a user via, for example, the control panel 120 (FIG. 2). The type set by the user is stored in the storage unit 150 by the controller 160. The character image type may also be referred to as a text image type.

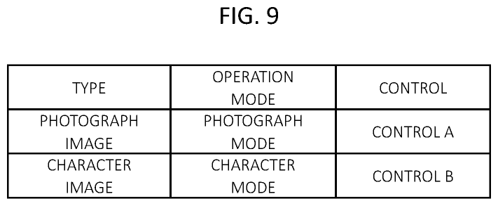

FIG. 9 is a diagram illustrating a correspondence between a type, an operation mode, and a control. When the type is a photo image, the controller 160 operates in a photograph mode and controls the heating element S in the control A. When the type is a character image (or a text image), the controller 160 operates in a character mode and controls the heating element S in the control B.

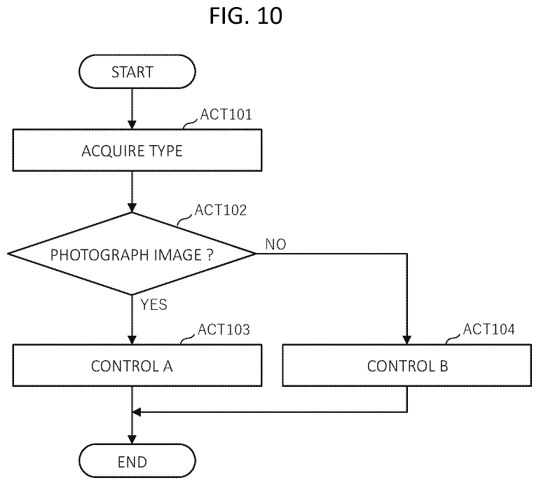

FIG. 10 is a flowchart illustrating a flow of control performed by the controller 160 according to one embodiment. The processing illustrated in the flowchart is executed when an image formation is started. The controller 160 acquires the type stored in the storage unit 150 (ACT 101). The controller 160 determines whether the acquired type is a photograph image (ACT 102). If the acquired type is a photo image (ACT 102: YES), the controller 160 controls the heating element S in the control A (ACT 103) and ends the processing. If the acquired type is not a photograph image (ACT 102: NO), the controller 160 controls the heating element S in the control B (ACT 104) and ends the processing. The control by the controller 160 is executed until the image formation is completed.

In this way, when the type is a photograph image, the controller 160 can maintain the print quality by controlling the heating element S in the control A. When the type is a character image, the controller 160 can heat the sheet without causing the heating element S to generate heat more than necessary. Thus, overall power consumption can be reduced.

### Modifications

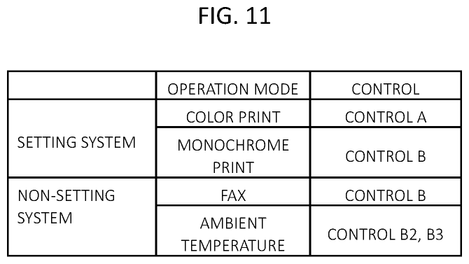

While the photograph mode and the character mode have been described as examples of the operation mode, another example mode of operation will be described herein. FIG. 11 is a diagram illustrating a correspondence between another operation mode and a control mode.

In the example of FIG. 11, there are two types of operation modes: an operation mode of a setting system according to a setting made by a user; and an operation mode of a non-setting system which does not depend on a setting made by a user. Examples of the operation mode of the setting system include a color printing mode and a monochrome printing mode. In a case of the color printing mode, since toner of the colors CMYK is transferred to a sheet, more heating is required as compared with a case of the monochromatic printing mode. Therefore, in a case of the color printing mode, the controller 160 controls the heating element S in the control A, and in a case of the monochrome printing mode, the controller 101 controls the heating element S in the control B. Accordingly, while the printing quality in the color printing mode is maintained, the sheet can be efficiently heated without causing the heating element S to generate heat more than necessary in the monochrome printing mode. Thus, the overall power consumption can be reduced.

Examples of the operation mode of the non-setting system include a facsimile mode and an ambient temperature mode. The facsimile mode is an operation mode in which a toner image indicating an image received by a facsimile is transferred to a sheet. An image received by a normal facsimile is a binary image and is monochrome printing. Therefore, in the facsimile mode, the controller 160 controls the heating element S in the control B. This makes it possible to efficiently heat the sheet without causing the heating element S to generate heat more than necessary. Thus, the overall power consumption can be reduced.

The ambient temperature mode is an operation mode in which the image forming apparatus 100 operates in accordance with an ambient temperature of the image forming apparatus 100. For example, comparing a case where the ambient temperature is lower than 10° C. and a case where the ambient temperature is 30° C. or higher, a temperature of the sheet, a temperature of the conveyance path, and the like are significantly different from each other. In one embodiment, a device capable of measuring the ambient temperature is provided in the image forming apparatus 100, and the ambient temperature is acquired from the device. Alternatively, the image forming apparatus 100 acquires the ambient temperature measured by another apparatus via a network or communication between these apparatuses. The image forming apparatus 100 controls the heating element S in the variably controllable control B2 and control B3 in accordance with the acquired ambient temperature. Accordingly, it is possible to efficiently heat the sheet without causing the heating element S to generate heat more than necessary. Thus, the overall power consumption can be reduced.

In other embodiments, the image forming apparatus 100 may operate with a combination of some or all of the above-described operation modes (the photograph mode, the character mode, the color printing mode, the monochrome printing mode, the facsimile mode, and the ambient temperature mode) with each other. For example, in a case of printing a color photographic image, an operation mode in which the photograph mode and the color printing mode are combined may be utilized.

In such combination of the operation modes, when there is an operation mode in the control A among the combined operation modes, the operation of the image forming apparatus 100 may be performed in the control A, and when there is no operation mode in the control A among the combined operation modes, the operation may be performed in the control B. That is, when there is at least one operation mode in the control A, the image forming apparatus 100 may control the heating element S by the control A. In the control A, the printing quality can be maintained in any of the operation modes, but in the control B, for example, the toner cannot be sufficiently heated fora color photograph image, and the printing quality may not be properly maintained.

Another control example may be a combination of the ambient temperature mode controlled by the controls B2 and B3 and the other operation modes. For example, the operation mode in which the character mode and the ambient temperature mode are combined is controlled by the same control B. In this combination, for example, the image forming apparatus 100 may perform: control in the control B3 when the ambient temperature is less than 10° C.; control in the control B2 when the ambient temperature is in a range of 10° C. or more and less than 30° C.; and control in the control B1 when the ambient temperature is 30° C. or more. Such operation with the combined operation modes makes it possible to heat the sheet without causing the heating element S to generate heat more than necessary. Thus, the overall power consumption can be reduced.

According to the image forming apparatus 100 of the embodiments described above, it is possible to provide an image forming apparatus capable of efficiently heating a sheet.

In other embodiments, it is possible to obtain not only an effect of efficiently heating a sheet but also other effects.

In the embodiments where the criterion for determining which control to perform is based on one or more of a setting by a user, whether a facsimile is received, an ambient temperature, and the like, the control criterion does not require an analysis of an image information of a document image.

On the other hand, in a case where an image information is analyzed and only a heating element corresponding to a position where the toner is transferred is caused to generate heat, such analysis of an image information requires hardware and the like, and a cost of the image forming apparatus increases.

Since the operation control according to the determination criterion that does not require the image information analysis can be realized by software, it is possible to significantly reduce a cost or prevent a cost increase. For example, since the determination based on the above setting can be realized by a simple “if sentence” as illustrated in FIG. 10, the cost can be reduced as compared with a case where additional hardware is added. Further, since many document images are images in which toner is transferred other than margins provided on upper, lower, left, and right sides of a sheet, it is possible to maintain the print quality for practical use without analyzing an image information.

Accordingly, the image forming apparatus 100 according to one or more of the present embodiments can maintain the print quality, can efficiently heat a sheet without causing heat generation of the heating element S more than necessary, and can further reduce manufacturing cost. Additionally, power consumption can be reduced.

The functions of the image forming apparatus according to the above-described embodiments may be realized by a computer executing program instructions. In this case, a program for realizing a function or functions may be recorded in a computer-readable recording medium, and the program may be read into a computer system and executed by the computer system. Note that the “computer system” as used in this context may include hardware, peripheral devices, and an operating system (OS), and the like. A “computer-readable recording medium” refers to a portable medium, such as a flexible disk, a magneto-optical disk, a ROM, or a CD-ROM, or a built-in storage device such as a hard disk of a computer system. Furthermore, a “computer-readable recording medium” may be a cloud-based storage system or a file server connected by a communication line in a case where a program is transmitted via a network such as the Internet or a communication line such as a telephone line. The program may be for realizing a part of the above-described functions or may be for realizing the above-described functions in combination with a program already recorded in the computer system.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The embodiments and modifications thereof are included in the scope and spirit of the invention, and are included in the invention described in the claims and the equivalent scope thereof.

1. An image forming apparatus, comprising:
a transfer unit configured to transfer a toner image to a sheet, the toner image corresponding to a document image to be formed on the sheet; and
a heating unit comprising a plurality of heating members arranged in row with each other along a sheet width direction orthogonal to a sheet conveyance direction and configured to heat the toner image on the sheet; and
a controller configured to individually control heat generation of the plurality of heating members in accordance with different operation modes of the image forming apparatus set based on an image type of the document image.

2. The image forming apparatus according to claim 1, wherein
the controller is configured to control the heat generation of the plurality of heating members in a first control mode and a second control mode, and
the heat generation of the plurality of heating members in the second control mode is less than the heat generation in the first control mode.

3. The image forming apparatus according to claim 2, wherein
when the operation mode is a photograph print mode, the controller is configured to control according to the first control mode, and
when the operation mode is a text image mode, the controller is configured to control according to the second control mode.

4. The image forming apparatus according to claim 2, wherein
when the operation mode is a color image mode, the controller is configured to control according to the first control mode, and
when operation mode is a monochrome image mode, the controller is configured to control according to the second control mode.

5. The image forming apparatus according to claim 2, wherein, when operation mode is a facsimile mode, the controller is configured to control according to only the second control mode.

6. The image forming apparatus according to claim 2, wherein the controller is further configured to cause a subset of the plurality of heating members to generate heat at a less than maximum power level in the second control mode.

7. The image forming apparatus according to claim 2, wherein, in the second control mode, the controller causes some heating members to generate heat at a maximum power level, some heating members to generate heat at a less than maximum power level, and some heating members to not generate heat at all.

8. The image forming apparatus according to claim 2, wherein the controller is further configured to individually set the heat generation for each of the heating elements in the second control mode.

9. The image forming apparatus according to claim 8, wherein the controller sets the heat generation for each of the heating elements by supplying different power levels to the respective heating elements.

10. The image forming apparatus according to claim 2, wherein, in the first control mode, the controller causes all of the plurality of heating members to generate heat.

11. The image forming apparatus according to claim 10, wherein the controller is further configured to cause all of the plurality of heating members to generate heat at a power level less than a maximum power level.

12. The image forming apparatus according to claim 1, wherein the controller is further configured to cause a subset of the plurality of heating members to generate heat at less than a maximum power level.

13. The image forming apparatus according to claim 1, wherein the controller adjusts the heat generation of the heating elements based on an ambient temperature.

14. The image forming apparatus according to claim 1, wherein the heating members are resistive heating elements.

15. An image forming apparatus, comprising:
a transfer belt configured to transfer a toner image corresponding to a document image to a sheet at a transfer position along a conveyance path of the sheet; and
a heater downstream of the transfer position along the conveyance path of the sheet, the heater comprising a plurality of resistive heating elements arranged in row along a width direction of the sheet; and
a controller configured to identify a type of the document image and, when the document image is a photograph image type, cause all of the resistive heating elements corresponding to a width of the sheet to generate heat at a first power level and, when the document image is a text image type, cause less than all of the resistive heating members corresponding to the width of the sheet to generate heat at the first power level.

16. The image forming apparatus according to claim 15, wherein the controller is configured to, when the document image is the text image type, cause a first subset of resistive heating elements from all the resistive heating elements corresponding to the width of the sheet to generate heat at the first power level and a second subset of resistive heating elements from all the resistive heating elements corresponding to the width of the sheet to generate heat at a second power level less than the first power level.

17. The image forming apparatus according to claim 15, wherein the controller is configured to, when the document image is the text image type, cause a first subset of resistive heating elements from all the resistive heating elements corresponding to the width of the sheet to generate heat at the first power level and a second subset of resistive heating elements from all the resistive heating elements corresponding to the width of the sheet not to generate heat.

18. An image forming apparatus, comprising:
a transfer unit configured to transfer a toner image corresponding to a document image to a sheet; and
a heating unit comprising a plurality of heating members arranged in a row along a width direction of the sheet; and
a controller configured to control the plurality of heating members according to a type of the document image, wherein
when the document image is a first image type, the controller supplies each heating member corresponding to a width of the sheet with a first power level, and
when the document image is a second image type, the controller supplies at least one heating member of the heating members corresponding to the width of the sheet with a second power level that is less than the first power level.

19. The image forming apparatus according to claim 18, wherein
the first image type is a color image, and
the second image type is a monochrome image.

20. The image forming apparatus according to claim 18, wherein
the first image type is a printer document image, and
the second image type is a facsimile document image.
